(19) United States
(12) Patent Application Publication
(10) Pub. No.: US 2015/0136532 A1
(43) Pub. Date: May 21, 2015

(54) TWO-PART SHEET METAL ELEVATOR GUIDERAIL

(71) Applicant: OTIS ELEVATOR COMPANY, Farmington, CT (US)

(72) Inventors: James L. Hubbard, Kensington, CT (US); Brad Guilani, Woodstock Valley, CT (US); Daryl J. Marvin, Farmington, CT (US); Zbigniew Piech, Cheshire, CT (US)

(21) Appl. No.: 14/413,484

(22) PCT Filed: Jul. 16, 2012
(86) PCT No.: PCT/US12/46861

§ 371 Date: Jan. 8, 2015

(51) Int. Cl. B66B 7/02; B21D 53/00; B66B 19/00; B21D 5/00

(52) U.S. Cl. CPC B66B 7/022; B21D 5/00; B21D 53/00; B66B 19/002
USPC 187/406; 29/428; 29/505

(57) ABSTRACT

An exemplary elevator guiderail includes a metal sheet bent into a configuration that establishes at least one mounting portion configured to facilitate mounting the guiderail within an elevator hoistway. At least one guiding portion is configured to guide movement of an elevator car along the guiderail. The metal sheet includes an exterior surface treated to resist corrosion. A cover over at least some of the guiding surface has an exterior that is different than the exterior surface of the metal sheet. The cover is configured to establish a coefficient of friction to facilitate brake engagement with the cover for resisting movement of an elevator car along the guiderail.

### BACKGROUND

Elevator systems typically include guiderails installed within a hoistway. The guiderails establish a path of movement for the elevator car. Elevator systems that include a counterweight also have counterweight guiderails for guiding vertical movement of the counterweight.

Conventional guiderails are formed from drawn steel and have a T-shaped cross-section. The rail is typically painted or coated to resist corrosion. The blade area of the rail along which guide components move is typically machined in an attempt to provide a smooth surface to facilitate a desired level of ride quality. The blade portion also provides an interface for engagement with elevator safeties.

While conventional guiderails have proven effective, they are not without drawbacks. Drawn steel guiderails introduce additional material cost into an elevator system. The mass of such guiderails introduces additional expenses associated with installation and transportation. The machining that is required to establish an appropriate thickness and surface of the blade area introduces additional manufacturing complexities and expenses.

### SUMMARY

An exemplary elevator guiderail includes a metal sheet bent into a configuration that establishes at least one mounting portion configured to facilitate mounting the guiderail within an elevator hoistway. At least one guiding portion is configured to guide movement of an elevator car along the guiderail. The metal sheet includes an exterior surface treated to resist corrosion. A cover over at least some of the guiding surface has an exterior that is different than the exterior surface of the metal sheet. The cover is configured to establish a coefficient of friction to facilitate brake engagement with the cover for resisting movement of an elevator car along the guiderail.

In an embodiment having the features of the preceding paragraph, the guiding portion comprises two guiding segments of the metal sheet parallel to each other with the exterior surface of the two guiding segments facing in opposite directions and the mounting portion comprises at least one mounting segment of the metal sheet that is situated generally perpendicular to the guiding segments.

In an embodiment having the features of one or more of the preceding paragraphs, there are two mounting segments spaced from each other.

In an embodiment having the features of one or more of the preceding paragraphs, there are two intermediate segments, each intermediate segment being between one of the guiding segments and the at least one mounting segment, the intermediate segments being situated at an oblique angle relative to the guiding segments.

In an embodiment having the features of one or more of the preceding paragraphs, there is a single mounting segment that extends between the intermediate segments.

In an embodiment having the features of one or more of the preceding paragraphs, one mounting segment is at an end of one of the intermediate segments and another mounting segment is at an end of the other of the intermediate segments.

In an embodiment having the features of one or more of the preceding paragraphs, a strengthening segment is at an end of each of the mounting segments, the strengthening segments being generally parallel to the guiding segments.

In an embodiment having the features of one or more of the preceding paragraphs, the metal sheet comprises galvanized steel and the cover comprises at least one of cold rolled metal, hot rolled metal, pickled and oiled metal or oil coated metal.

In an embodiment having the features of one or more of the preceding paragraphs, the cover comprises at least one sheet of metal secured to at least a portion of the guiding portion.

In an embodiment having the features of one or more of the preceding paragraphs, the cover comprises a bent sheet of metal having a first cover segment on one side of the guiding portion, a second cover segment generally perpendicular to the first cover segment, and a third cover segment generally parallel to the first cover segment, the third cover segment being on another side of the guiding portion that faces in an opposite direction from the one side.

In an embodiment having the features of one or more of the preceding paragraphs, the cover comprises two sheets that are each secured to a distinct surface of the guiding portion.

An exemplary method of making an elevator guiderail includes bending a metal sheet to establish a guiding portion and a mounting portion. The guiding portion includes at least one guiding segment of the metal sheet. The guiding portion is configured to guide movement of an elevator car along the guiderail. The mounting portion includes at least one mounting segment of the metal sheet. The mounting portion is configured to facilitate mounting the guiderail within an elevator hoistway. The method includes securing a cover to at least the guiding portion during the process of bending the metal sheet.

An embodiment having the features of the preceding paragraph, includes bending the cover into position over the guiding portion.

An embodiment having the features of one or more of the preceding paragraphs comprises adhesively securing the cover to the guiding portion.

In an embodiment having the features of one or more of the preceding paragraphs, the metal sheet includes an exterior surface treated to resist corrosion and the cover includes an exterior that is different than the exterior surface of the metal sheet, the cover exterior being configured to establish a coefficient of friction to facilitate brake engagement with the cover for resisting movement of an elevator car along the guiderail.

An embodiment having the features of one or more of the preceding paragraphs comprises bending the metal sheet at a first location a selected distance from one edge of the metal sheet to thereby establish a guiding segment of the metal sheet between the first location and the one edge; bending the metal sheet at a second location a selected distance from the first location to thereby establish an intermediate segment between the first location and the second location, the intermediate segment being at an oblique angle relative to the guiding segment; bending the metal sheet at a third location a selected distance from the second location to thereby establish a mounting segment between the second location and the third location, the mounting segment being generally perpendicular to the guiding segment; bending the metal sheet at a fourth location a selected distance from the third location to thereby establish a second intermediate segment between the third location and the fourth location, the second intermediate segment being at an oblique angle relative to the mounting segment; and bending the metal sheet at a fifth location a selected distance from the fourth location to thereby establish a second guiding segment between the fifth location and another edge of the metal sheet, the second guiding segment being parallel to the guiding segment between the first location and the one edge.

An embodiment having the features of one or more of the preceding paragraphs, comprises bending the metal sheet at a first location a selected distance from one edge of the metal sheet to thereby establish a first mounting segment of the metal sheet between the first location and the one edge; bending the metal sheet at a second location a selected distance from the first location to thereby establish an intermediate segment between the first location and the second location, the intermediate segment being at an oblique angle relative to the first mounting segment; bending the metal sheet at a third location a selected distance from the second location to thereby establish a first guiding segment between the second location and the third location, the first guiding segment being generally perpendicular to the first mounting segment; bending the metal sheet at a fourth location a selected distance from the third location to thereby establish a second guiding segment between the third location and the fourth location, the second guiding segment being parallel to the first guiding segment; and bending the metal sheet at a fifth location a selected distance from the fourth location to thereby establish a second intermediate segment between the fourth location and the fifth location and a second mounting segment between the fifth location and another edge of the metal sheet, the second intermediate segment being at an oblique angle relative to the second guiding segment, the second mounting segment being generally parallel with the first mounting segment.

An embodiment having the features of one or more of the preceding paragraphs comprises making an additional bend in the metal sheet at a selected location on each mounting portion to thereby establish a strengthening segment between each additional bend and the corresponding edge of the metal sheet, wherein the strengthening segments are generally perpendicular to the mounting portions.

An embodiment having the features of one or more of the preceding paragraphs comprises positioning a sheet of cover material adjacent the metal sheet and simultaneously establishing at least one bend in each of the sheet of cover material and the metal sheet.

An exemplary method of installing an elevator guiderail includes bending a metal sheet to establish a guiding portion and a mounting portion. The guiding portion includes at least one guiding segment of the metal sheet. The guiding portion is configured to guide movement of an elevator car along the guiderail. The mounting portion includes at least one mounting segment of the metal sheet. The mounting portion is configured to facilitate mounting the guiderail within an elevator hoistway. The bent metal sheet is situated in a desired orientation at a site of the elevator system that is to include the guiderail. A cover is secured to at least the guiding portion while the guiderail is at the site of the elevator system.

The various features and advantages of disclosed example embodiments will become apparent to those skilled in the art from the following detailed description. The drawings that accompany the detailed description can be briefly described as follows.

### BRIEF DESCRIPTION OF THE DRAWINGS

Nom FIG. 1 schematically illustrates selected portions of an example elevator system including guiderails designed according to an embodiment of this invention.

FIG. 2 is an end view of an example guiderail designed according to an embodiment of this invention.

FIG. 3 is an end view of another example guiderail.

FIG. 4 is an end view of another example guiderail.

FIG. 5 is a perspective illustration showing one feature of one example embodiment.

### DETAILED DESCRIPTION

FIG. 1 schematically illustrates selected portions of an elevator system 20. An elevator car 22 is situated within a hoistway 24. Elevator car guiderails 30 are positioned within the hoistway 24 to establish a vertical path along which the elevator car 22 can move. Guidance devices schematically shown at 32 can include roller guides or sliding guide shoes that follow along the guiderails 30. Elevator safeties schematically shown at 34 engage the guiderails 30 during a braking application for purposes of resisting movement of the elevator car 22 under selected circumstances.

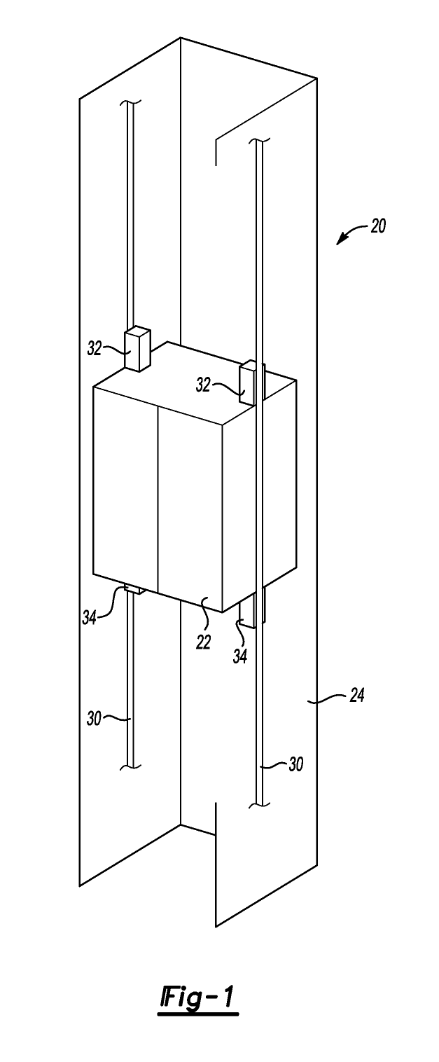

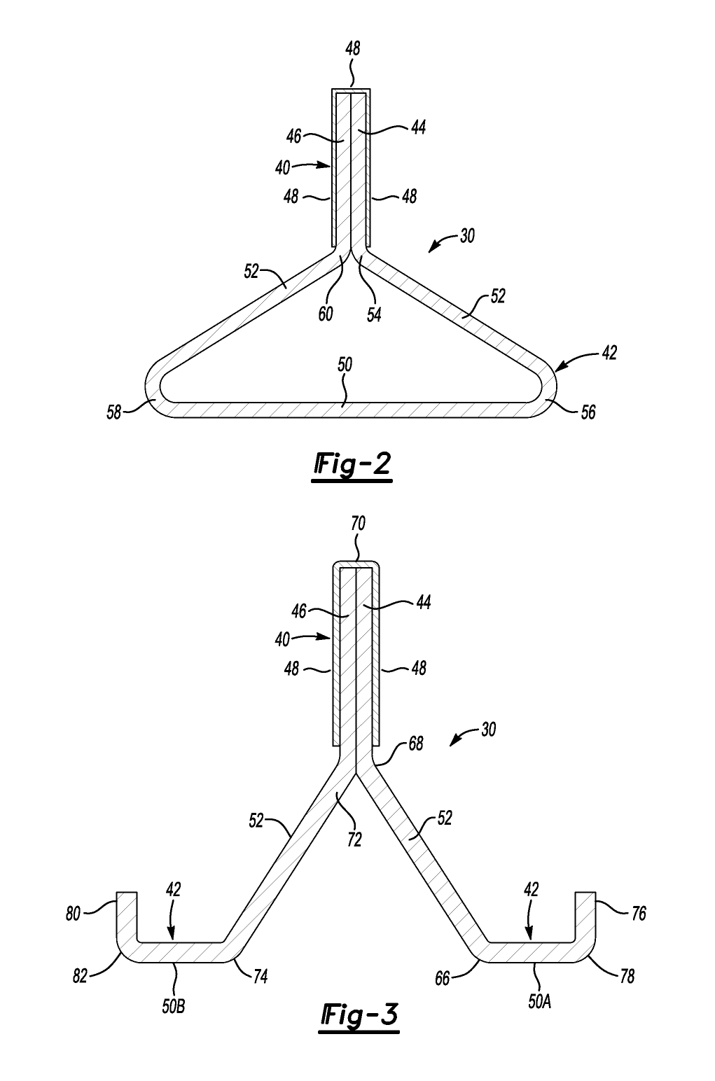

The guiderails 30 differ from traditional car guiderail configurations. The guiderails 30 comprise a bent metal sheet. One example embodiment is shown in FIG. 2. A metal sheet is bent into a configuration to establish a guiding portion 40 and a mounting portion 42. The guiding portion 40 is configured to guide movement of the elevator car 22 along the guiderail 30. The mounting portion 42 is configured to facilitate mounting the guiderail 30 within the hoistway 24.

In the example of FIG. 2, the guiding portion 40 includes two guiding segments 44 and 46. Each guiding segment 44, 46 comprises a section of the metal sheet that is bent into the configuration shown in FIG. 2.

In one example, the metal sheet comprises galvanized steel. In another example, the metal sheet includes a coating or treatment for resisting corrosion. Galvanized steel or metal treated for corrosion resistance does not provide an appropriate interface for a braking application of an elevator safety. The example of FIG. 2 includes a cover 48 over the guiding portion 40. The cover 48 has an exterior that is different than the exterior surface of the metal sheet from which the guiding segments 44 and 46 are established. The exterior of the cover 48 is configured to establish a coefficient of friction between the cover material and a braking portion of an elevator safety to facilitate brake engagement with the cover 48 for resisting movement of the elevator car 22 along the guiderail 30.

In one example, the cover 48 comprises metal, which may be different than the metal used for the metal sheet that is bent into the configuration to establish the guiding portion 40 and the mounting portion 42 of the guiderail 30. In one example, the cover 48 comprises a cold rolled or hot rolled, uncoated sheet steel. Another example comprises a known pickled and oiled steel. Another example cover 48 comprises a mechanically de-scaled steel. Still another example cover 48 comprises a roughened surface steel. The cover 48 allows for using a galvanized metal such as steel as the body of the guiderail 30. Galvanization typically interferes with establishing an appropriate coefficient of friction between guiderails and elevator safeties. The cover 48 allows for using galvanized metal and achieving an appropriate coefficient of friction.

The cover 48 may be secured to the guiding portion 40 in one of several manners. One example includes applying an adhesive to either the guiding segments 46 and 44 or the cover 48 and positioning the cover 48 in the desired orientation over the guiding portion 40. Another example includes a pre-applied adhesive tape or film on one of the surfaces that is an interface between the guiding portion 40 and the cover 48. Another example includes welding the cover 48 in place. Other examples include clinching, crimping or another mechanical securing technique such as including locking tabs for securing the cover 48 in place.

In some examples, the cover 48 is secured to the guiding portion at a manufacturing facility. In other examples, the cover 48 may be secured to the guiding portion 40 at the installation site of the elevator system that will include the guiderail 30. Such field assembly allows for using a plurality of bent metal sheets to establish the entire vertical length of the guiderails 30 and using a single piece cover applied continuously over the full rail length. Such a cover eliminates joints that a roller or sliding guide has to pass over during movement of the elevator car. A continuous, uninterrupted surface of the cover 48 improves elevator ride quality.

The example of FIG. 2 includes a single mounting segment 50 that is oriented generally transverse, such as perpendicular, to the guiding segments 44 and 46. The mounting segment 50 facilitates securing the guide rail 30 to a hoistway wall or a bracket that then mounts to a hoistway wall, for example. Intermediate segments 52 extend between the mounting segment 50 and the guiding segments 44 and 46. As can be appreciated from the illustration, the intermediate segments 52 are at an oblique angle relative to the guiding segments 44, 46 and relative to the mounting segment 50.

An example method of making the elevator guiderail 30 includes bending a metal sheet at a first location 54 a selected distance from an edge of the metal sheet. Bending the metal sheet at the first location 54 establishes the guiding segment 44 between the first location 54 and the edge of the metal sheet. Bending the metal sheet at a second location 56 a selected distance from the first location 54 establishes the intermediate segment 52 between the first location 54 and the second location 56. Bending the metal sheet at a third location 58 a selected distance from the second location 56 establishes the mounting segment 50 between the second location 56 and the third location 58. The angles selected for the bends at the locations 54 and 56 establish the perpendicular orientation between the guiding segment 44 and the mounting segment 50 in this example. Bending the metal sheet at a fourth location 60 establishes the intermediate segment 52 between the third location 58 and the fourth location 60. The bend at the fourth location 60 also establishes the guiding segment 46 between the fourth location 60 and the other edge of the metal sheet.

In one example, the stiffness of the metal sheet and the angles selected for each bend in the metal sheet positions the guiding segments 44 and 46 adjacent to each other in a sufficiently stable manner that no further processing is required to achieve a stable guiderail body. In some examples, an adhesive is provided between the guiding segments 44 and 46 to maintain them in a desired alignment adjacent each other. In another example, a spot welding technique is used for securing the guiding segments 44 and 46 adjacent to each other in a desired alignment.

FIG. 3 illustrates another example embodiment of the guiderail 30. One difference between the arrangement in FIG. 2 and that shown in FIG. 3 is that the guiding segments 44 and 46 are formed from a central portion of the metal sheet in FIG. 3 compared to being formed from end portions in the embodiment of FIG. 2. Another feature of FIG. 3 that is different than the embodiment of FIG. 2 is that two mounting segments 50a, 50b are provided instead of the single mounting segment 50 of FIG. 2.

One example method of making the embodiment of FIG. 3 includes bending a metal sheet at a first location 66 a selected distance from one edge of the metal sheet. The bend at the first location 66 establishes the mounting segment 50a between the first location 66 and an edge of the metal sheet. Bending the metal sheet at a second location 68 a selected distance from the first location 66 establishes the intermediate segment 52 between the first location 66 and the second location 68. Bending the metal sheet at a third location 70 establishes the guiding segment 44 between the third location 70 and the second location 68. Bending the metal sheet at a fourth location 72 establishes the guiding segment 46 between the third location 70 and the fourth location 72. Bending the metal sheet at a fifth location 74 establishes the intermediate segment 52 between the fifth location 74 and the fourth location 72. Bending the metal sheet at the fifth location 74 also establishes the guiding segment 50b between the fifth location 74 and the other edge of the metal sheet.

The example of FIG. 3 includes a bend at a selected location 78 along the length of the mounting segment 50a for establishing a strengthening member 76 between the mounting segment 50a and the corresponding edge of the metal sheet. Another strengthening member 80 is established between the other edge of the metal sheet and a location 82 along the length of the mounting segment 50b. The strengthening members 76 and 80 add structural stability and stiffness to the guiderail 30.

One feature of an example like that shown in FIG. 3 is that it is possible to incorporate the cover 48 onto the bent metal sheet during the bending process. For example, a piece of metal for the cover 48 is situated adjacent to the metal sheet used for establishing the guiding segments 44 and 46. When bending the metal sheet at the third location 70, the piece of metal used for the cover 48 is bent at the same time so that it is bent into the position shown at FIG. 3. Simultaneously bending two pieces of metal at the same time may introduce manufacturing economies for providing a completed guiderail 30 that incorporates a cover 48 over the guiding portion 40. An adhesive may be optionally used to further enhance the connection between the cover 48 and the guiding segments 44 and 46.

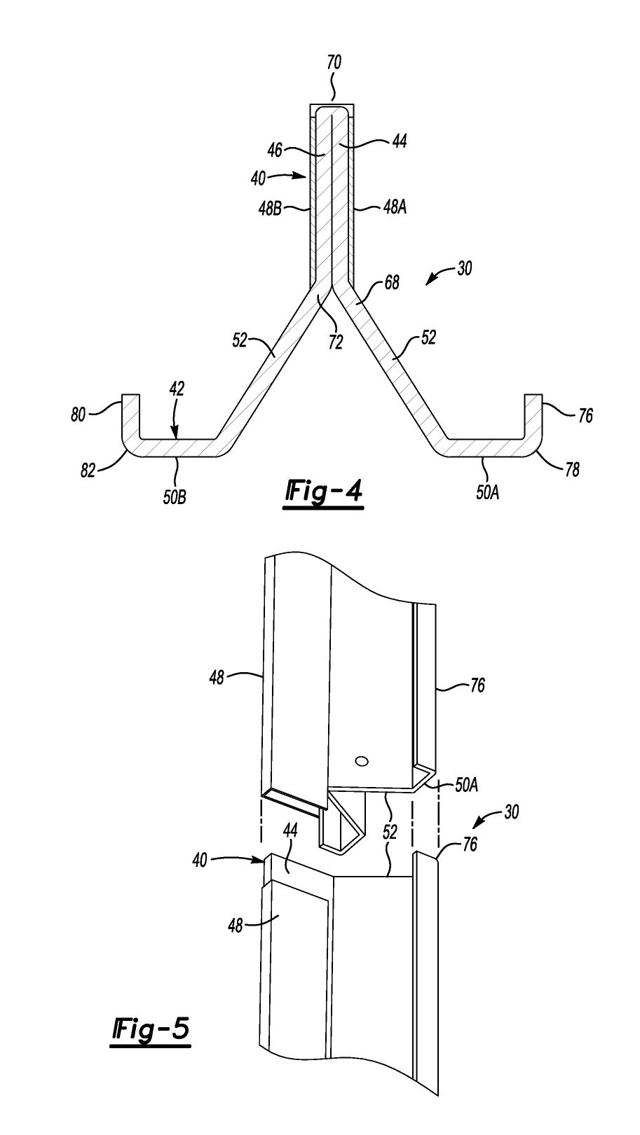

FIG. 4 illustrates another example embodiment in which the metal sheet is bent in the same configuration as the embodiment of FIG. 3. The cover 48 in the example of FIG. 4 is different compared to the covers 48 shown in the examples of FIG. 2 and FIG. 3. In the example of FIG. 4, the cover 48 comprises a first cover portion 48a secured to an exterior surface of the guiding segment 44. Another cover portion 48b is secured to an exterior surface of the guiding segment 46. The two individual cover portions 48a, 48b are secured to the corresponding guiding segments 44, 46 using an adhesive in one example.

One feature of the embodiment of FIG. 4 is that it allows for a roll of cover material to be manipulated at the elevator system installation site and placed into the position shown in FIG. 4. Another feature of the embodiment of FIG. 4 is that it eliminates any requirement for bending the metal that is used for establishing the cover portions 48a and 48b.

FIG. 5 illustrates a feature of another example embodiment. In FIG. 5, the guide rail 30 comprises multiple sections 30a and 30b that are situated adjacent to each other to establish the entire vertical length of the guiderail 30. In this example, a portion of the cover 48 extends beyond the corresponding guiding portion 40 of the section 30a. Some of the guiding portion 40 of the adjacent section 30b is exposed (i.e., not covered by the corresponding section of cover 48 in the illustration). As the guiderail sections 30a and 30b are moved together, the exposed guiding portion 40 of the section 30b is received within the length of the cover 48 that extends beyond the guiding portion of the section 30a. Such an arrangement facilitates alignment between adjacent sections of the guiderail 30. This alignment feature enhances ride quality and simplifies an installation process.

One of the features of the illustrated example embodiments is that they provide a lower cost guiderail compared to the conventional T-shaped drawn steel guiderails. The illustrated examples allow for achieving corrosion protection by using a galvanized or appropriately coated material for establishing the guiding portion 40 and mounting portion 42 of the guiderail 30. The separate cover 48 allows for establishing an appropriate surface that facilitates a proper coefficient of friction between the guiderail 30 and elevator safeties 34 for braking applications as needed.

The ability to use two different materials allows for optimizing the weight and strength of the guiderail 30. The cover 48 over the guiding portion 40 allows for establishing a flat area for an elevator car guide 32 to follow along and this is achievable without complex or expensive machining. The illustrated examples also allow for improving elevator ride quality by eliminating rail joints along the vertical length of the rail. Although described as being used with a car guide rail, the disclosed guiderail configuration could be used with a counterweight guiderail, particularly in arrangements in which the counterweight requires safeties.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An elevator guide rail, comprising:
a metal sheet comprising a first metal bent into a configuration that establishes at least one mounting portion configured to facilitate mounting the guiderail within an elevator hoistway and at least one guiding portion configured to guide movement of an elevator car or counterweight along the guiderail, the metal sheet including an exterior surface treated to resist corrosion; and
a cover over at least some of the guiding surface, the cover comprising a second, different metal having an exterior that is different than the exterior surface of the metal sheet, the cover exterior being configured to establish a coefficient of friction to facilitate brake engagement with the cover for resisting movement of an elevator car or counterweight along the guiderail.

2. The elevator guide rail of claim 1, wherein
the guiding portion comprises two guiding segments of the metal sheet parallel to each other with the exterior surface of the two guiding segments facing in opposite directions; and
the mounting portion comprises at least one mounting segment of the metal sheet that is situated generally perpendicular to the guiding segments.

3. The elevator guide rail of claim 2, wherein there are two mounting segments spaced from each other.

4. The elevator guide rail of claim 2, wherein there are two intermediate segments, each intermediate segment being between one of the guiding segments and the at least one mounting segment, the intermediate segments being situated at an oblique angle relative to the guiding segments.

5. The elevator guide rail of claim 4, wherein there is a single mounting segment that extends between the intermediate segments.

6. The elevator guide rail of claim 4,
wherein one mounting segment is at an end of one of the intermediate segments and another mounting segment is at an end of the other of the intermediate segments.

7. The elevator guide rail of claim 6, comprising a strengthening segment at an end of each of the mounting segments, the strengthening segments being generally parallel to the guiding segments.

8. The elevator guide rail of claim 1, wherein
the metal sheet comprises galvanized steel; and
the cover comprises at least one of cold rolled metal, hot rolled metal, pickled and oiled metal or oil coated metal.

9. The elevator guide rail of claim 1, wherein
the cover comprises at least one sheet of metal secured to at least a portion of the guiding portion.

10. The elevator guide rail of claim 9, wherein the cover comprises a bent sheet of metal having
a first cover segment on one side of the guiding portion,
a second cover segment generally perpendicular to the first cover segment, and
a third cover segment generally parallel to the first cover segment, the third cover segment being on another side of the guiding portion that faces in an opposite direction from the one side.

11. The elevator guide rail of claim 9, wherein the cover comprises two sheets that are each secured to a distinct surface of the guiding portion.

12. A method of making an elevator guide rail, comprising the steps of:
(A) bending a metal sheet comprising a first metal to establish
a guiding portion from at least a guiding segment of the metal sheet, the guiding portion being configured to guide movement of an elevator car or counterweight along the guiderail and
a mounting portion from at least a mounting segment of the metal sheet, the mounting portion being configured to facilitate mounting the guiderail within an elevator hoistway; and
(B) securing a cover comprising a second, different metal to at least the guiding portion during step (A).

13. The method of claim 12, wherein step (B) includes bending the cover into position over the guiding portion.

14. The method of claim 12, wherein step (B) comprises adhesively securing the cover to the guiding portion.

15. The method of claim 12, wherein
the metal sheet includes an exterior surface treated to resist corrosion; and
the cover includes an exterior that is different than the exterior surface of the metal sheet, the cover exterior being configured to establish a coefficient of friction to facilitate brake engagement with the cover for resisting movement of an elevator car along the guiderail.

16. The method of claim 12, wherein step (A) comprises
bending the metal sheet at a first location a selected distance from one edge of the metal sheet to thereby establish a guiding segment of the metal sheet between the first location and the one edge;
bending the metal sheet at a second location a selected distance from the first location to thereby establish an intermediate segment between the first location and the second location, the intermediate segment being at an oblique angle relative to the guiding segment;
bending the metal sheet at a third location a selected distance from the second location to thereby establish a mounting segment between the second location and the third location, the mounting segment being generally perpendicular to the guiding segment;
bending the metal sheet at a fourth location a selected distance from the third location to thereby establish a second intermediate segment between the third location and the fourth location, the second intermediate segment being at an oblique angle relative to the mounting segment; and
bending the metal sheet at a fifth location a selected distance from the fourth location to thereby establish a second guiding segment between the fifth location and another edge of the metal sheet, the second guiding segment being parallel to the guiding segment between the first location and the one edge.

17. The method of claim 12, wherein step (A) comprises
bending the metal sheet at a first location a selected distance from one edge of the metal sheet to thereby establish a first mounting segment of the metal sheet between the first location and the one edge;
bending the metal sheet at a second location a selected distance from the first location to thereby establish an intermediate segment between the first location and the second location, the intermediate segment being at an oblique angle relative to the first mounting segment;
bending the metal sheet at a third location a selected distance from the second location to thereby establish a first guiding segment between the second location and the third location, the first guiding segment being generally perpendicular to the first mounting segment;
bending the metal sheet at a fourth location a selected distance from the third location to thereby establish a second guiding segment between the third location and the fourth location, the second guiding segment being parallel to the first guiding segment; and
bending the metal sheet at a fifth location a selected distance from the fourth location to thereby establish a second intermediate segment between the fourth location and the fifth location and a second mounting segment between the fifth location and another edge of the metal sheet, the second intermediate segment being at an oblique angle relative to the second guiding segment, the second mounting segment being generally parallel with the first mounting segment.

18. The method of claim 17, comprising
making an additional bend in the metal sheet at a selected location on each mounting portion to thereby establish a strengthening segment between each additional bend and the corresponding edge of the metal sheet, wherein the strengthening segments are generally perpendicular to the mounting portions.

19. The method of claim 12, comprising
positioning a sheet of cover material adjacent the metal sheet; and
simultaneously establishing at least one bend in each of the sheet of cover material and the metal sheet.

20. A method of installing an elevator guide rail, comprising the steps of:
(A) bending a metal sheet comprising a first metal to establish
a guiding portion from at least a guiding segment of the metal sheet, the guiding portion being configured to guide movement of an elevator car along the guiderail and
a mounting portion from at least a mounting segment of the metal sheet, the mounting portion being configured to facilitate mounting the guiderail within an elevator hoistway;
(B) situating the bent metal sheet in a desired orientation at a site of an elevator system that is to include the guide rail; and
(C) securing a cover comprising a second, different metal to at least the guiding portion while the bent metal sheet is at the site of the elevator system.
